(19) United States
(12) Patent Application Publication
(10) Pub. No.: US 2017/0180360 A1
(43) Pub. Date: Jun. 22, 2017

(54) SYSTEM FOR SECURING USER IDENTITY INFORMATION AND A DEVICE THEREOF

(71) Applicant: CENTRE FOR DEVELOPMENT OF ADVANCED COMPUTING (CDAC), Thiruvananthapuram (IN)

(72) Inventors: Jiju Kuttipalakkal, Thiruvananthapuram (IN); Arya Girija Lal, Thiruvananthapuram (IN); Stanley Regis Muthuswamy, Thiruvananthapuram (IN)

(21) Appl. No.: 15/389,091

(22) Filed: Dec. 22, 2016

(30) Foreign Application Priority Data
Dec. 22, 2015 (IN) 6837/CHE/2015

(51) Int. Cl. H04L 29/06; G06Q 40/02; H04W 12/06

(52) U.S. Cl. CPC H04L 63/0861; H04L 63/0853; H04L 63/083; H04W 12/06; G06Q 40/02; H04W 4/008

(57) ABSTRACT

Embodiments of present disclosure relates to system for securing user identity information comprising an authentication device associated to a computing device for authenticating the user identity information. The authentication device comprises a control unit, a user interface, a memory, a bio-metric sensor, and a communication interface. The control unit receives authentication request from the computing device and/or second authentication device. The control unit receives secure identity input towards authentication request from the user. The control unit verifies the received secure identity input with pre-stored user secure identity information and transmits the secure identity input to computing device and second authentication device for verifying secure identity input with the pre-stored user secure identity information. The control unit authenticates the user identity information based on matching of the secure identity input with the pre-stored user secure identity information.

### CROSS-REFERENCE TO RELATED APPLICATION

The present application claims priority to Indian Patent Application No. 6837/CHE/2015, entitled “SYSTEM FOR SECURING USER IDENTITY INFORMATION AND A DEVICE THEREOF,” filed on Dec. 22, 2015. The entire contents of which are hereby incorporated by reference for all purposes.

### TECHNICAL FIELD

The present subject matter is related, in general to user authentication, and more particularly, but not exclusively to a system and an authentication device for securing identity information of a user from theft and/or revealing.

### BACKGROUND

Presently, one or more different identity information are required towards financial and non-financial transactions, for example, e-commerce transaction, monetary transaction, user identification, files access, door access, etc. in one scenario or type of transaction, a user is required to input password, personal information, credentials for accessing account information in a bank and/or for making any monetary transaction. In another scenario or type of transaction, a user is required to use a physical card, which include, without limitation, debit card, credit card, identification card, Pan card, voter identification card etc., towards monetary transaction and/or user identification, e.g. for voting. The user may not remember the credentials like card number etc. while making the transactions. In such cases, the user has to retain various types of cards physically for making any kind of transaction. Thus, maintaining and managing plurality of these cards is a difficult task. In some scenarios, the password and/or other credentials may be overseen or overlooked by a person standing next to the user while inputting the password and/or the credentials during the transaction process. Further, in some remote areas, there are a limited number of Automated Teller Machines (ATMs) present or availability of card based devices is not used by some shops or stores. Thus, usage of the physical card is not possible in such cases or limited.

In one conventional method, online banking or net banking or mobile banking is carried out which requires network connectivity. However, such a transaction may fail due to failure of the network connectivity. In another conventional method, one or more devices are used to input password and credentials of the user. However, such one or more devices require network connectivity of their own, which in some cases may fail due to network connectivity issues. In another conventional method, a verification device is used for authenticating the user information like password and credentials. However, such verification device does not provide a link to the transaction where the origin of the transaction is enabled. Due to such failure, there may result fraud and theft of the user information and may fail the transaction as well.

The issues mainly faced in securing identification information of a user are storing and protecting the one or more identification information from theft and/or security breaches as well providing a means for offline money transaction.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

In one embodiment, the present disclosure relates to a system for securing user identity information comprising an authentication device associated to a computing device for authenticating user identity information. The authentication device comprises a control unit, a user interface, a memory, and at least communication network interface. The control unit is configured to receive an authentication request from at least one of the computing device and a second authentication device associated to a second computing device. The control unit is configured to receive at least one secure identity input of a user towards the authentication request from the user. The control unit is configured to perform, upon receipt of the at least one secure identity input, at least one of verify the received at least one secure identity input of the user with a pre-stored user secure identity information stored in a memory of the authentication device and transmit the received at least one secure identity input of the user to the at least one of the computing device and the second authentication device for verifying the received at least one secure identity input of the user with a pre-stored user secure identity information stored in a memory of the computing device. The control unit is configured to authenticate the user identity information based on matching of the at least one secure identity input of the user with the pre-stored user secure identity information. The user interface is associated with the control unit. The user interface comprises at least one of at least one biometric sensor and one or more icons for receiving the at least one secure identity input of the user and a display unit for displaying the at least one of an icon corresponding to the at least one biometric sensor and the one or more icons and a result of the authentication. The memory is configured to store the pre-stored user secure identity information. The at least one communication network interface is associated with the control unit for providing one or more modes of communication between at least one of the computing device, the authentication device, the second computing device and the second authentication device.

In one embodiment, the present disclosure relates to an authentication device for authenticating user identity information. The authentication device is associated with a computing device and comprises a control unit, a user interface, a memory, and at least communication network interface. The control unit is configured to receive an authentication request from at least one of the computing device and a second authentication device associated to a second computing device. The control unit is configured to receive at least one secure identity input of a user towards the authentication request from the user. The control unit is configured to perform, upon receipt of the at least one secure identity input, at least one of verify the received at least one secure identity input of the user with a pre-stored user secure identity information stored in a memory of the authentication device and transmit the received at least one secure identity input of the user to the at least one of the computing device and the second authentication device for verifying the received at least one secure identity input of the user with a pre-stored user secure identity information stored in a memory of the computing device. The control unit is configured to authenticate the user identity information based on matching of the at least one secure identity input of the user with the pre-stored user secure identity information. The user interface is associated with the control unit. The user interface comprises at least one of at least one biometric sensor and one or more icons for receiving the at least one secure identity input of the user and a display unit for displaying the at least one of an icon corresponding to the at least one biometric sensor and the one or more icons and a result of the authentication. The memory is configured to store the pre-stored user secure identity information. The at least one communication network interface is associated with the control unit for providing one or more modes of communication between at least one of the computing device, the authentication device, the second computing device and the second authentication device.

The foregoing summary is illustrative only and is not intended to be in any way limiting. In addition to the illustrative aspects and features described above, further aspects, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment illustrating an authentication system and a device thereof for securing user identity information;

FIG. 2A illustrates a detailed block diagram of an authentication device for securing user identity information in accordance with some embodiments of the present disclosure;

FIG. 2B shows an exemplary environment illustrating communication between an authentication device and a second authentication device in accordance with some embodiments of the present disclosure;

FIG. 2C and FIG. 2D show an exemplary view of a display unit in the computing device in accordance with some embodiments of the present disclosure;

FIG. 3 shows a flowchart illustrating an exemplary method for securing user identity information at the computing device in accordance with some embodiments of the present disclosure; and

FIG. 4 shows a flowchart illustrating operations of an authentication device in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates to a system for securing user identity information comprising an authentication device associated to a computing device for authenticating user identity information. The authentication device comprises a control unit, a user interface, a memory, and a communication network interface. The control unit receives authentication request from the computing device and/or second authentication device. The control unit receives secure identity input towards authentication request from user. The control unit verifies the received secure identity input with pre-stored user secure identity information. Further, the control unit transmits the secure identity input to the computing device and the second authentication device for verifying secure identity input with the pre-stored user secure identity information. The control unit authenticates the user identity information based on the match of secure identity input with the pre-stored user secure identity information.

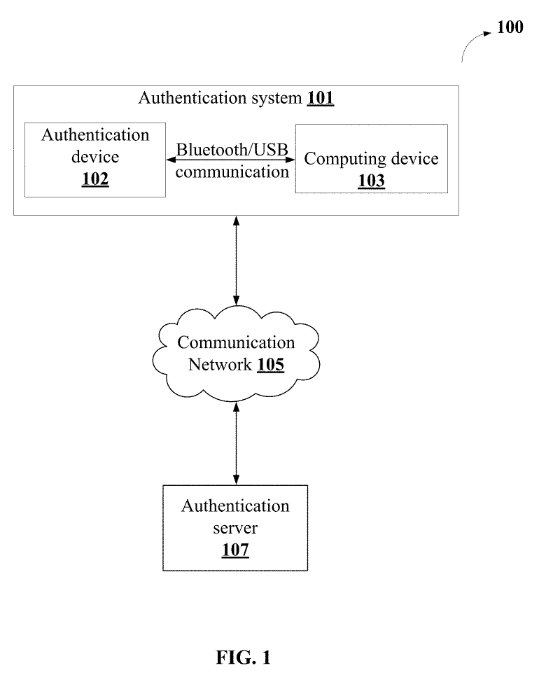

FIG. 1 shows an exemplary environment 100 illustrating an authentication system 101 associated to an authentication server 107 using a communication network 105. In an embodiment, the authentication system 101 comprises an authentication device 102 and a computing device 103. The authentication device 102 uses a biometric sensor 121 to sense the input received from the user for authenticating the user for performing any transaction through the authentication system 101. The computing device 103 may be a smart phone, laptop and/or personal computer, which can be connected to the communication network 105 via a wired or wireless connection. The communication network 105 may include, but not limited to, a wired communication network, a wireless communication network and any combination thereof. The authentication server 107 may be a simple web server that stores various data including one or more web pages and web applications related to the authentication system 101. Additionally, the authentication server 107 may also store one or more transaction details, include, but are not limited to, the user account details, account login credentials and a list comprising details of the one or more previous transactions performed by the user. In an embodiment, the authentication server cross verifies the saved transactional details with one or more transactional details received from the user and informs the concerned personnel in case a mismatch and/or a security breach is detected. In such a case, the authentication device may be deactivated until the above stated issue is solved.

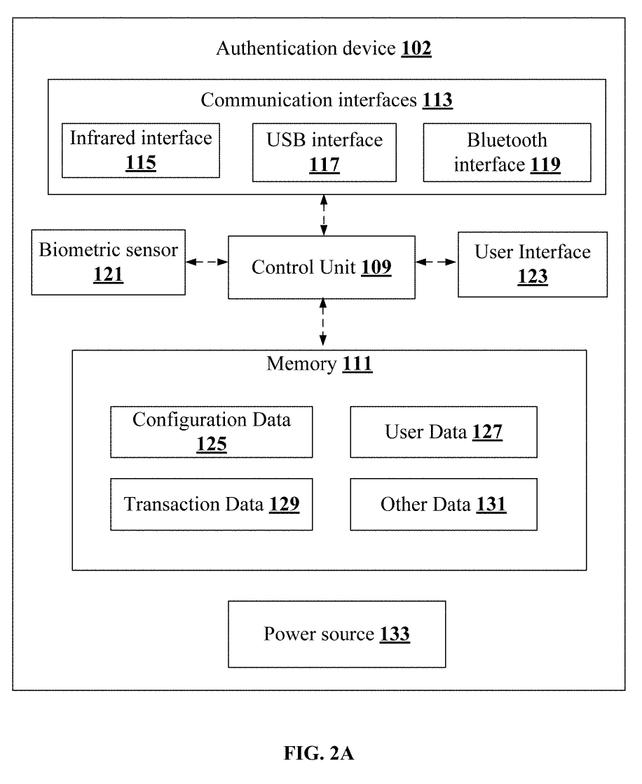

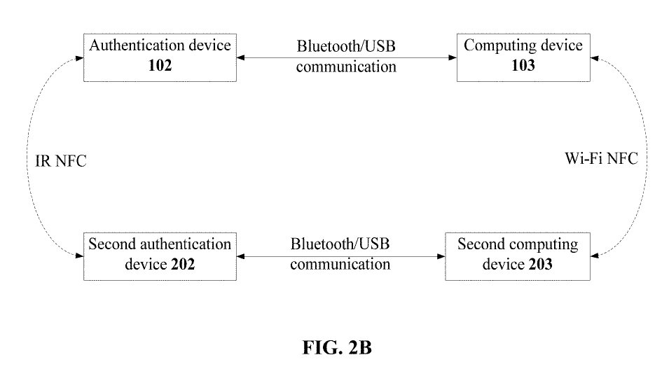

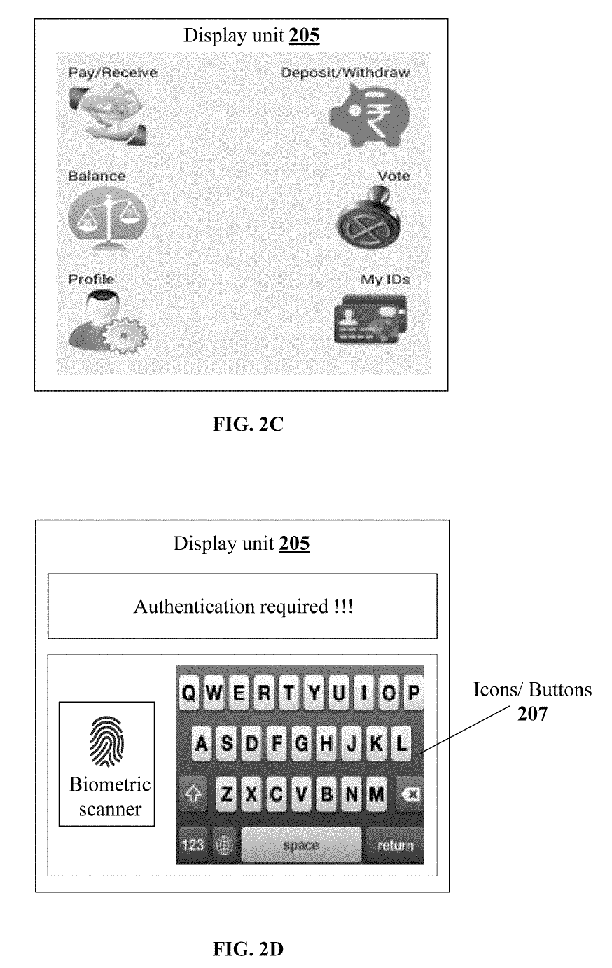

FIG. 2A illustrates a detailed block diagram of an authentication device for securing user identity information in accordance with some embodiments of the present disclosure.

The authentication device 102 comprises a control unit 109, a memory 111, one or more communication interfaces 113, a biometric sensor 121, a user interface 123 and a power source 133. The one or more communication interfaces 113 may include, but not limited to, an Infrared interface 115, USB interface 117 and a Bluetooth interface 119. The one or more communication interfaces 113 configured in the authentication device 102 guarantee a timely transaction without the risk of network failure.

In an embodiment, as shown in FIG. 2B, the authentication device 102 may use one of the one or more communication interfaces 113 to communicate with the computing device 103 and/or a second authentication device 202 for authenticating the corresponding devices for performing one or more transactions. The authentication device 102 and the corresponding computing device 103 may use at least one of Bluetooth, Wi-Fi and Universal Serial Bus (USB) connectivity for communicating with each other. In an embodiment, the authentication system 101 may communicate with a second authentication system 201 using at least one of offline transaction and online transaction. During the offline transaction, the authentication system 101 communicates with the second authentication system 201 using at least one of Wi-Fi Near Field Communication (NFC) and Infra-Red (IR) NFC. Alternatively, during the online transaction, the authentication system 101 may communicate with the second authentication system 201 using an internet connection through web server.

In an embodiment, the authentication device 102 may be communicatively connected to a computing device 103 for carrying out a transaction. Upon initiating any transaction through the computing device 103, the authentication device 102 receives authentication request from the computing device 103. In an embodiment, the authentication system 101 may receive authentication request from the second authentication system 201 in which the second authentication device 202 is communicatively connected to the second computing device 203 similar to the way in which the authentication device 102 is connected to the computing device 103. In such a case, there is a transaction enabled between one authentication system 101 and the other authentication system 201 where both the authentication devices are connected to corresponding computing devices 103 and 203 respectively. Further, the authentication system 101 receives authentication request from the second authentication system 201. Upon receiving the authentication request, the authentication device 102 displays the request on a user interface 123 of the authentication device 102.

In an embodiment, the computing device 103 may be configured with a software application that enables easy and convenient interaction of the user with the authentication device 102. FIG. 2C shows an exemplary display unit 205 in the computing device 103. The application on the computing device 103 may present one or more transaction options to each of the authenticated users once they are verified by the authentication device 102. As an example, the transaction options presented to the user may include, but not limited to, an option to pay/receive money, an option to deposit/withdraw money, an option to check account balance, an option to make an electronic vote, an option to verify/change user profile and an option to manage, verify and edit one or more identification cards of the user. In another embodiment, the software application on the computing device 103 may be used to encrypt the one or more secure identification information being sent to the authentication device 102. The one or more secure information may include, but not limited to, the pin code/password entered by the user, the biometrics information of the user etc. Similarly, the software application may also decrypt the one or more secure identification information received from the authentication device 102, thus enhancing the security of the exchange of critical information.

In an embodiment, as shown in FIG. 2D, the user interface 123 of the authentication device 102 may access a display unit 205 in the computing device 103 and one or more icons/buttons 207 in the display unit 205 for receiving one or more inputs from the user. The authentication device 102 may further comprise a biometric sensor 121 which may be used to scan the finger tip of the user for authenticating the user. In an embodiment, the biometric sensor 121 is a specially designed device that scans the vein patterns under the skin or the unique features in fingertip of a human being. The user is allowed to perform one or more transactions through the computing device only when the user's biometric identification is matched with pre-stored secure identity information of the user. In an alternative embodiment, the users may use the one or more icons/buttons 207 on the display unit 205 for entering a pre-stored pin code/password for authenticating themselves with the authentication device 102. In an embodiment, a part of the display unit 205 may be used to display one or more notifications and/or alerts to the user. As an example, the display unit 205 may display an alert message saying “Authentication required! ! !” when an unauthorised user attempts to transact using the authentication device 102.

In an embodiment, the authentication device 102 further verifies the secure identity input received by the user with the pre-stored user secure identity information which is stored in the authentication device 102. Then, the authentication device 102 transmits authentication information to the computing device 103 over the communication interface for completing the transaction based on matching of the secure identity input of the user with the pre-stored user secure identity information. The authentication device 102 transmits the secure identity input to the computing device 103 over the communication interface for verification to authenticate the user identity information based on matching of the secure identity input of the user with the pre-stored user secure identity information. In an embodiment, the user secure identity information may be stored in the memory 111 of the authentication device 102. Alternatively, the user secure identity information may also be stored on the authentication server 107 in order to protect the secure identity information from theft or unauthorized access.

In addition to the secure identity information, the memory 111 may also store one or more data related to the authentication system 101 and the users of the authentication system 101. In an embodiment, the data stored in the memory 111 may include, but not limited to, configuration data 125, user data 127, transaction data 129 and other data 131 related to the authentication system 101.

In an embodiment, the configuration data 125 may include one or more configuration information related to the authentication system 101. As an example, the configuration data 125 may include a data list indicating one or more computing devices 103 paired with the authentication device 102, device set-up and initialization data, network details etc.

In an embodiment, the user data 127 includes one or more data related to the one or more users of the authentication system 101. As an example, the user data 127 may include, but not limited to, user preference and/or settings, account login credentials of the user and details of the one or more identification cards saved on the authentication device 102.

In an embodiment, the transaction data 129 may include details related to the previous transactions of the user. The users may refer to the transaction data 129 in order to check the status of their account before performing a fresh transaction. As an example, the transaction data 129 may be stored in the form of spread sheet, for example, Microsoft™ Excel data sheet in a time stamped manner for an easy and convenient use by the user.

In an embodiment, the other data 131 may include one or more temporary data and temporary files generated by the one or more communication interfaces 113 and the biometric sensor 121 while performing the various functions of the control unit 109.

In an embodiment, the authentication system 101 may be powered by a power source 133 to perform one or more operations and transactions described hereinabove. As an example, the power source 133 may be a re-chargeable battery cell that can be charged at the convenience of the user.

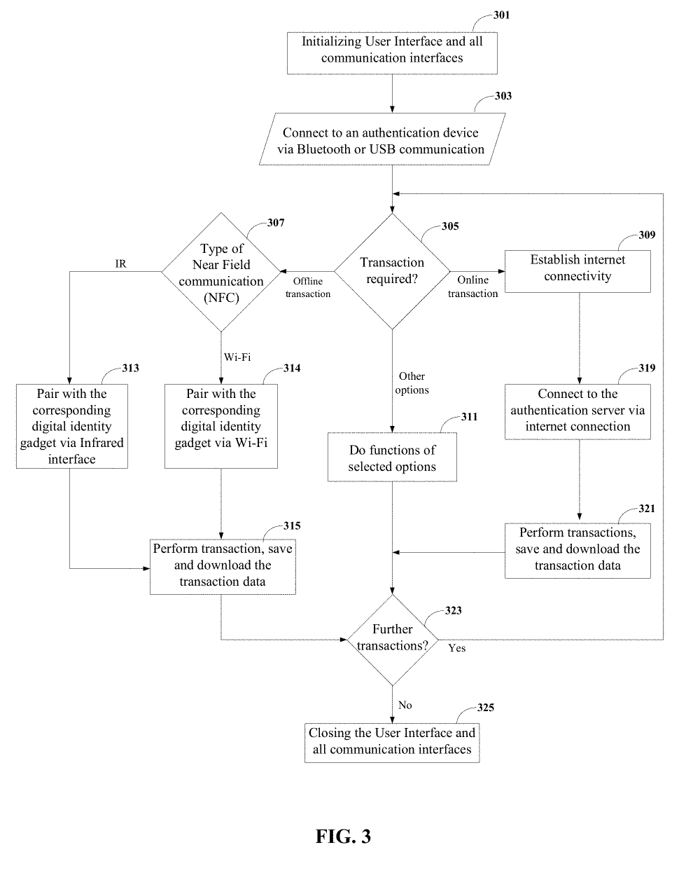

FIG. 3 shows a flowchart illustrating an exemplary method for securing user identity information in accordance with some embodiments of the present disclosure.

At step 301, the control unit 109 in the authentication device 102 initializes the user interface 123 and the one or more communication interfaces 113. After the initialization, at step 303, the authentication device 102 connects to a corresponding computing device 103 and/or the second authentication device 201 using an appropriate communication interface. Before performing a transaction, the authentication device 102 authenticates the users by verifying and comparing the secure identification information received from the users with the pre-stored secure identification information of the user. If the user is authenticated, the user may perform one or more transactions using the computing device 103. In an embodiment, the transaction 305 between the authentication device 102 and the computing device 103 and/or the second authentication device 202 and the second computing device 203 may be one of offline transaction and online transaction. During online transaction, at step 309, the authentication device 102 uses the communication network 105 to connect to the authentication server 107 as shown in step 319. As shown in step 321, upon connecting to the authentication server 107, the user may perform one or more required transactions and store the transaction data 129 back on the memory of the authentication server 107. In an embodiment, the software application installed on the computing device 103 may be updated to a latest available version of software when connected to the internet.

Alternatively, during offline transaction, as shown in step 307, the authentication device 102 selects one of the NFC methods, such as the IR NFC and the Wi-Fi NFC to connect to a corresponding computing device 103 (for Wi-Fi NFC) and/or the second authentication device 202 (for IR NFC) for performing one or more transactions as shown in step 313 to 315. In an embodiment, the IR NFC may be comparatively faster than the Wi-Fi NFC since the authentication device 102 automatically pairs with the nearest line of sight device 202, thus avoiding the need for searching the device.

In an embodiment, as shown in step 311, the user may also perform one or more actions other than the monetary transactions, including checking the account balance, making an electronic vote, verifying and changing the user profile and managing, verifying and saving one or more identification cards on the memory 111. Further, the user may also save the one or more transaction details on the authentication server 107 and download the previously saved transaction details whenever it is needed.

As shown in step 323, upon completing each active transaction, the authentication device 102 checks for the one or more transactions pending to be performed. In an embodiment, the authentication device moves back to the step 305 when the authentication device finds one or more pending transactions. Alternatively, if there are no pending transactions, the authentication device 102 suspends each of the communication interfaces 113 and the user interface 123 and terminates the current user session as shown in step 325.

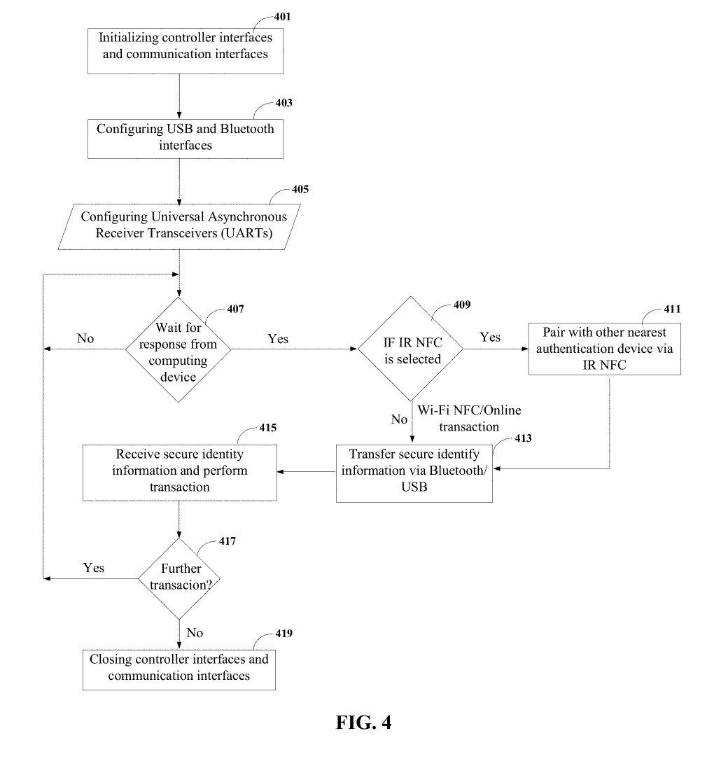

FIG. 4 shows a flowchart illustrating operations of an authentication device in accordance with some embodiments of the present disclosure.

At step 401, the control unit 109 in the authentication device 102 initializes the one or more controller interfaces such as, Input Output (I/O) interfaces and the one or more communication interfaces 113 configured in the authentication device 102. After initializing each of the communication interfaces 113, the authentication device 102, at step 403, configures the one or more communication interfaces 113, such as Bluetooth and USB, required for performing the one or more transactions. Further, at step 405, the authentication device 102 configures the one or more Universal Asynchronous Receiver Transceivers (UARTs), such as, the biometric scanner, Bluetooth, IR NFC and Wi-Fi NFC. As shown in step 407, the authentication device 102 waits for a request and/or response message from the computing device 103 to initiate a transaction with the computing device 103. At step 409, after receiving the request and/or response from the computing device 103, the authentication device 102 checks whether the IR NFC is selected as a communication interface for performing the transaction. If the IR NFC is selected, the authentication device 102 pairs with the respective computing device 103 using the IR NFC, as shown in step 411. Alternatively, if the IR NFC is not selected for performing the transaction, the Bluetooth interface 119 and/or the USB interface 117 are used for transferring the one or more secure identity information from the computing device 103 as shown in step 413. Further, at step 415, the authentication device 102 receives the one or more secure identity information from the computing device 103 and performs the one or more transactions upon authenticating the computing device 103 using the received one or more secure identity information. At step 417, the authentication device 102 checks for the one or more transactions pending to be performed. If there are no transactions pending to be performed, the control unit 109 of the authentication device 102 suspends each of the one or more controller interface and the communication interfaces 113 as shown in step 419.

### Advantages of the Embodiment of the Present Disclosure are Illustrated Herein

Embodiments of the present disclosure provide a consolidated accessory for securing one or more identification information of a user.

Embodiment of the present disclosure enables a user to perform offline transaction alongside online transaction, thus avoiding a dependency on internet connectivity.

Embodiments of the present disclosure provide a means for reducing socio-economic problems such as, bribery, corruption, black money etc.

The authentication system disclosed in the present disclosure provides a secure online voting system, which can be used for election purposes, thus saving the time, manpower and expenditure associated with an election process.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

Referral Numerals:

| Reference | |
|---|---|
| Number | Description |
| 100 | System environment |
| 101 | Authentication system |
| 102 | Authentication device |
| 103 | Computing device |
| 105 | Communication network |
| 107 | Authentication server |
| 109 | Control unit |
| 111 | Memory |
| 113 | Communication interfaces |
| 115 | Infrared interface |
| 117 | USB interface |
| 119 | Bluetooth interface |
| 121 | Biometric sensor |
| 123 | User Interface |
| 125 | Configuration data |
| 127 | User data |
| 129 | Transaction data |
| 131 | Other data |
| 133 | Power source |
| 201 | Second authentication system |
| 202 | Second authentication device |
| 203 | Second computing device |
| 205 | Display unit |
| 207 | Icons/Buttons |

1. A system for securing user identity information comprising:
an authentication device, associated to a computing device, for authenticating user identity information, the authentication device comprising:
a control unit configured to:
receive an authentication request from at least one of the computing device and a second authentication device associated to a second computing device;
receive at least one secure identity input of a user towards the authentication request from the user;
perform, upon receipt of the at least one secure identity input, at least one of:
verify the received at least one secure identity input of the user with a pre-stored user secure identity information stored in a memory of the authentication device;
transmit the received at least one secure identity input of the user to the at least one of the computing device and the second authentication device for verifying the received at least one secure identity input of the user with a pre-stored user secure identity information stored in a memory of the computing device; and
authenticate the user identity information based on matching of the at least one secure identity input of the user with the pre-stored user secure identity information;
a user interface, associated with the control unit, comprising:
at least one of at least one biometric sensor and one or more icons for receiving the at least one secure identity input of the user; and
a display unit for displaying the at least one of an icon corresponding to the at least one biometric sensor and the one or more icons and a result of the authentication;
a memory configured to store the pre-stored user secure identity information;
at least one communication network interface, associated with the control unit, for providing one or more modes of communication between at least one of the computing device, the authentication device, the second computing device and the second authentication device; and
at least one web server which stores transaction details of each of the authentication devices and facilitates alerts, check systems and payment transaction between banks and the authentication devices.

2. The system as claimed in claim 1, wherein the authentication device is associated to an authentication server to store authentication details performed by the authentication device.

3. The system as claimed in claim 1, wherein the at least one secure identity input of a user comprises at least one of a biometric input of the user and a text password input of the user.

4. The system as claimed in claim 1 secures the user identity information for at least one of offline based transaction and online based transaction.

5. An authentication device for authenticating user identity information, the authentication device comprising:
a control unit configured to:
receive an authentication request from at least one of the computing device and a second authentication device associated to a second computing device;
receive at least one secure identity input of a user towards the authentication request from the user;
perform, upon receipt of the at least one secure identity input, at least one of:
verify the received at least one secure identity input of the user with a pre-stored user secure identity information stored in a memory of the authentication device;
transmit the received at least one secure identity input of the user to the at least one of the computing device and the second authentication device for verifying the received at least one secure identity input of the user with a pre-stored user secure identity information stored in a memory of the computing device; and
authenticate the user identity information based on matching of the at least one secure identity input of the user with the pre-stored user secure identity information;
a user interface, associated with the control unit, comprising:
at least one of at least one biometric sensor and one or more icons for receiving the at least one secure identity input of the user; and
a display unit for displaying the at least one of an icon corresponding to the at least one biometric sensor and the one or more icons and a result of the authentication;
a memory configured to store the pre-stored user secure identity information;
at least one communication network interface, associated with the control unit, for providing one or more modes of communication between at least one of the computing device, the authentication device, the second computing device and the second authentication device; and
at least one web server which stores transaction details of each of the authentication devices and facilitates alerts, check systems and payment transaction between banks and the authentication devices.

6. The authentication device as claimed in claim 5 is associated to an authentication server to store authentication details received from the authentication device.

7. The authentication device as claimed in claim 5, wherein the at least one secure identity input of a user comprises at least one of a biometric input of the user and a text password input of the user.

8. The authentication device as claimed in claim 5 secures the user identity information for at least one of offline based transaction and online based transaction.
